(19) United States
(12) Patent Application Publication
(10) Pub. No.: US 2014/0258072 A1
(43) Pub. Date: Sep. 11, 2014

(54) METHODS, SYSTEMS, AND MEDIA FOR EXECUTING TRADES IN FINANCIAL INSTRUMENTS

(71) Applicant: LCH.Clearnet Limited, New York, NY (US)

(72) Inventors: Aaron Mayor, Putnam Valley, NY (US); Nathan J. Ondyak, New York, NY (US)

(73) Assignee: LCH.Clearnet Limited, New York, NY (US)

(21) Appl. No.: 14/198,461

(22) Filed: Mar. 5, 2014

Related U.S. Application Data
(60) Provisional application No. 61/773,398, filed on Mar. 6, 2013.

(51) Int. Cl. G06Q 40/06

(52) U.S. Cl. CPC G06Q 40/06
USPC 705/37

(57) ABSTRACT

A central counterparty receives a contract having transaction terms associated with an interest rate swap (IRS) and a position of a security, the transaction terms including an expiration date. Upon the expiration date and in a case of a physical settlement of the contract the IRS is generated based on the transaction terms. The central counterparty facilitates delivery of the security from a second counterparty to a first counterparty and starting on a specified date after the expiration date, receives payment of a fixed side of the IRS from the first counterparty, pays the fixed side of the IRS to the second counterparty, receives a floating side of the IRS from the second counterparty, and pays the floating side of the IRS to the first counterparty. In a case of a cash settlement of the contract and upon a specified date after the expiration date the contract is cash settled based on a market value of the contract.

### CROSS REFERENCE TO RELATED APPLICATION

This application claims priority to U.S. Provisional Application No. 61/773,398 filed Mar. 6, 2013, the contents of which are incorporated herein by reference.

### BACKGROUND

1. Field

Example aspects described herein relate generally to trading financial instruments and more particularly to executing trades in financial instruments.

2. Related Art

The market commonly trades interest rate swaps as a spread to an underlying benchmark, such as a government bond. Trading as a spread involves entering into a swap contract (for example, an agreement to pay a fixed rate and receive a floating rate on a 10 year tenor) and a bond position (for example, a purchase of a 10 y US treasury security).

There are mechanisms that allow participants to take exposure to government securities via a future/forward contract that entitles a holder to take or provide delivery of a government security on a future date in a cleared environment, and there are mechanisms that allow participants to take exposure to forward swaps (or swap futures) in a fully cleared environment. These existing mechanisms allow participants to create spread exposure between these two (2) types of instruments. However, this spread exposure is a function of exposure to the individual components, and is not an exposure to a spread itself on a forward date. As a consequence, the spread exposure may require dynamic hedging to stay DV01-neutral throughout the life of the contract and at final settlement. There is no known cleared mechanism—in a fully cleared world where a clearinghouse become a central counterparty to the trade—to take exposure to a swap spread itself on a forward date, providing for a contract that does not require dynamic hedging to stay DV01-neutral throughout its life and at final settlement.

### BRIEF DESCRIPTION

The example embodiments described herein provide methods, systems and computer program products for executing a trade are provided. A central counterparty receives a contract having transaction terms associated with an interest rate swap (IRS) and a position of a security, the transaction terms including an expiration date. Upon the expiration date and in a case of a physical settlement of the contract the IRS is generated based on the transaction terms. The central counterparty facilitates delivery of the security from a second counterparty to a first counterparty and starting on a specified date after the expiration date, receives payment of a fixed side of the IRS from the first counterparty, pays the fixed side of the IRS to the second counterparty, receives a floating side of the IRS from the second counterparty, and pays the floating side of the IRS to the first counterparty. In a case of a cash settlement of the contract and upon a specified date after the expiration date the contract is cash settled based on a market value of the contract.

### BRIEF DESCRIPTION OF THE DRAWINGS

The features and advantages of the example embodiments presented herein will become more apparent from the detailed description set forth below when taken in conjunction with the following drawings.

FIG. 1 illustrates an example system which can be used to implement the embodiments of the invention.

FIG. 2 is a flow diagram of a process for processing a trade in accordance with an example embodiment of the invention.

FIG. 3 is a flow diagram of a process for clearing a trade in accordance with an example embodiment of the invention.

FIG. 4 is a flow diagram of a process for marking a trade to market in accordance with an example embodiment of the invention.

FIG. 5 is a flow diagram of a process for settling a trade in accordance with an example embodiment of the invention.

### DETAILED DESCRIPTION

In accordance with some embodiments, mechanisms for clearing trades in financial instruments are provided. In some embodiments, these mechanisms can receive information relating to a trade, can mark the trade to market, can determine if the trade has expired, and can settle the trade.

Any suitable financial instrument(s) can be used with these mechanisms. For example, in some embodiments, these mechanisms can be used with a forward swap spread. In some embodiments, a forward swap spread can be a contract that provides that (i) a long position in the contract entitles the holder of the long position to pay the fixed side of an interest rate swap starting on a specified date and purchase and receive delivery of a corresponding treasury security in exchange for a specified amount based on a specified yield from a CCP on the specified date, and (ii) a short position in the contract entitles the holder of the short position to receive the fixed side of an interest rate swap starting on a specified date and deliver a corresponding treasury security to the CCP in exchange for the specified amount based on a specified yield on a specified date.

In some embodiments, the forward swap spread can be based on any suitable combination of any suitable type(s) of fixed rate interest, floating rate interest, and bond yield. For example, in some embodiments, the reference interest rate swap may be a USD, EUR, AUS, CAD, or JPY swap while the reference bond yield can be based on U.S., German, U.K., Italian, Australian, Canadian, or Japanese debt.

Another example of a financial instrument that can be used with these mechanisms is a forward starting swap. In some embodiments, a forward starting swap can be a contract that provides that a counterparty to a contract either pays or receives a fixed rate starting on a specified date.

In some embodiments, the forward starting swap can be based on any suitable combination of any suitable type(s) of fixed rate interest and floating rate interest.

Another example of a financial instrument that can be used with these mechanisms is a forward treasury. In some embodiments, a forward treasury can be a contract that provides that (i) a long position in the contract entitles the holder of the long position to receive delivery of a corresponding treasury security in exchange for a specified amount based on a specified yield from a CCP on a specified date, and (ii) a short position in the contract requires the holder of the short position to sell and deliver a corresponding treasury security to the CCP in exchange for a specified yield based amount of cash on the specified date.

In some embodiments, this forward treasury can be a net of a trade in a forward swap spread and a trade in a forward starting swap.

In some embodiments, the forward treasury can be based on any suitable combination of any suitable type(s) of bond yield. For example, in some embodiments, the bond yield can be based on U.S., German, U.K., Italian, Australian, or Canadian debt.

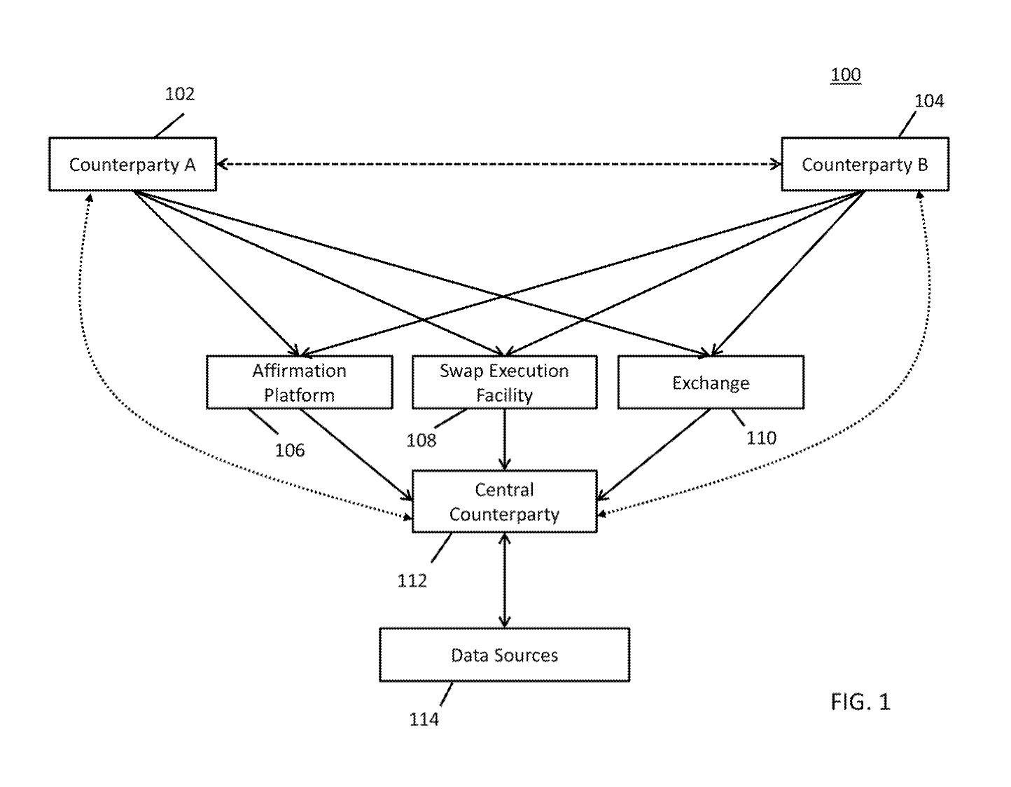

Turning to FIG. 1, an example 100 of hardware that can be used to implement some embodiments is illustrated. As shown hardware 100 can include counterparty A computers 102, counterparty B computers 104, an affirmation platform 106, a swap execution facility 108, an exchange 110, central counterparty computers 112, and data sources 114.

Affirmation platform 106 can be any suitable platform where the parties to an oral trade can record the terms for delivery to central counterparty computers 112. Swap exchange facility 108 can be any suitable platform for regulated trading of swaps. Exchange 110 can be any exchange for executing swap trades. Data sources 114 can be any suitable sources of data required for pricing trades in the instruments described herein and can include dealer banks, commercial data sources, markets, exchanges, and/or any other suitable data sources.

Any one or more of counterparty A computers 102, counterparty B computers 104, affirmation platform 106, swap execution facility 108, exchange 110, central counterparty computers 112, and data sources 114 can be implemented as a general purpose device such as a computer or a special purpose device such as a client, a server, etc. Any of these general or special purpose devices can include any suitable components such as a hardware processor (which can be a microprocessor, digital signal processor, a controller, etc.), memory, communication interfaces, display controllers, input devices, etc.

Further details on examples of financial instruments that can be used in some embodiments are now provided.

As described above, in accordance with some embodiments, a financial product called a forward swap spread can be used with the mechanisms provided herein. In some embodiments, the forward swap spread can be a forward obligation of the spread between a future starting interest rate swap and a forward delivery treasury.

For example, in some embodiments, buying the forward swap spread (i.e., entering into a long position) obligates the buyer, prior to or upon expiry oldie forward swap spread, to roll the forward swap spread to a new expiration or to physically settle into (or cash settle the spot equivalent of): (a) an interest rate swap payer position in which the buyer pays a fixed rate and receives three month LIBOR on an interest rate swap for 10 years; and (b) buys a ten year on-the-run US Treasury note.

As another example, in some embodiments, selling the forward swap spread (i.e., entering into a short position) obligates the seller, prior to or upon expiry of the forward swap spread, to roll the forward swap spread to a new expiration or to physically settle into (or cash settle the spot equivalent of): (a) an interest rate swap position in which the seller receives a fixed rate and pays three month LIBOR on an interest rate swap for 10 years; and (b) sells a ten year on-the-run US Treasury note.

In some embodiments, this forward swap spread can be specified in any suitable currency. For example, in some embodiments, the forward swap spread can be specified in U.S. dollars.

In some embodiments, the forward swap spread can have any suitable expiration and maturity. For example, in some embodiments, the maturity can be two years, three years, five years, ten years, thirty years, or any other suitable period of time.

In some embodiments, the forward swap spread can have any suitable expiration date. For example, in some embodiments, the forward swap spread can have standardized expiration dates. For example, in some embodiments, the expiration dates may be quarterly specified fixed dates.

Any suitable interest rate swap can be the basis for a forward swap spread in some embodiments. For example, in some embodiments, an interest rate swap can be for “a semi 30/360” on the fixed side and for a “3m LIBOR act/360” on the floating side. In this example, “semi 30/360” designates that the fixed side sets to an agreed-upon fixed rate, pays semi-annually, and accrues on a 30/360 day count basis, and “3m LIBOR act/360” designates that the floating side sets to three month LIBOR and accrues interest on an actual 360 day count basis.

In some embodiments, the yield spread can be quoted in any suitable manner. For example, in some embodiments, the yield spread can be quoted as the difference between a swap yield corresponding to the forward swap spread and an on-the-run treasury yield corresponding to the forward swap spread.

For example, in some embodiments, buying a forward swap spread at 50 basis points (which is equivalent to 0.50% of yield) may require the buyer to, upon expiration, physically settle (or cash settle the equivalent of, or roll the position forward) by: (a) entering into an interest rate swap in which the buyer pays, for ten years, a fixed interest rate equal to the yield of the ten year on-the-run U.S. Treasury (at a specified time on the day of expiration of the forward swap spread) plus 50 basis points, and in which the buyer receives three month LIBOR for ten years; and (b) purchasing a ten year on-the-run US Treasury note.

In some embodiments, any suitable quote convention can be used. For example, in some embodiments, the forward swap spread can be quoted in forward spread yield at ¼ basis point increments (i.e., 0.0025% increments).

In some embodiments, any suitable lot sizes can be used. For example, in some embodiments, lot sizes can represent the swap notional.

In some embodiments, the offsetting treasury side of the spread can represent a weighted treasury position (as described below), rounded to the nearest $1 M in US Treasury notional (notional for a US treasury note or bond might also be referred to in certain circumstances as the par value of the trade or in other circumstances as the face value of the note or bond), as determined by any suitable hedge ratios (hedge ratios are the ratios of how many treasuries one would need to offset a swap based on offsetting interest rate risk of the swap).

In some embodiments, hedge ratios may follow market convention and may equal the DV01 weighted treasury hedge of the swap. That is, the amount of notes passed in physical settlement can be equal to the swap DV01 divided by the treasury DV01 based on the locked treasury price that determines the yield for the treasury portion of the spread, rounded to the nearest $1M, in some embodiments.

In some embodiments, the DV01 may change over the life of the trade and become a final DV01 at the time of expiry of the swap spread for a final price (and NPV (net present value), cash value, mark to market value or treasury hedge amount for physical settlement). In some embodiments, for the life of the forward swap spread, the treasury and swap positions may be looked at as a delta neutral spread—not as the risk of the individual components—and the price or yield level of the forward swap spread may be determined as a spread level.

In some embodiments, the forward swap spread can have an associated “forwardness” amount that represents the difference between the forward swap spread and the spot swap spread. This forwardness can be determined in any suitable manner. For example, in some embodiments, the forwardness can be determined empirically by dealer banks calculating the difference in market prices between the forward swap spread and the spot swap spread or by calculating the forward swap spread value. As another example, in some embodiments, the forwardness can be calculated by algorithm.

In some embodiments, a financial product representing a forward starting swap can be used with the mechanisms provided herein. The terms of the forward starting swap can be set to match the terms of the interest rate swap portion of the underlying economic elements of a forward swap spread.

In some embodiments, a financial product called a forward treasury or creating a forward treasury exposure can be used with the mechanisms provided herein. The terms of the forward treasury can be set to match the terms of the treasury portion of the underlying economic elements of a forward swap spread. The forward treasury can be realized by packaging a forward swap spread and an offsetting forward starting swap as an amalgam trade in some embodiments.

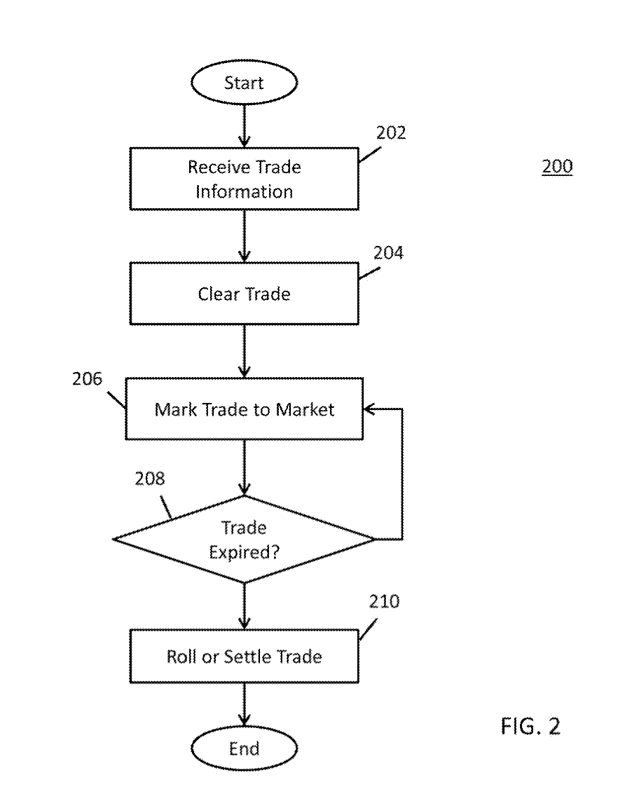

FIGS. 2-5 provide examples of processes that can be performed on central counterparty computers 112 in accordance with some embodiments.

Turning to FIG. 2, a flow diagram of an example 200 of a process for processing a trade in accordance with some embodiments is shown. Process 200 can be used to process any suitable type of trade. For example, as described further below, process 200 can be used to process a forward swap spread as described herein.

For example, two counterparties (e.g., counterparty A 102 and counterparty B2 104 of FIG. 1) can agree to the terms of a trade in a forward swap spread. Any suitable terms can be agreed to in some embodiments. For example, the two counterparties can agree to a price and any suitable standard, public forward swap spread specification. This agreement can be reached in any suitable manner. For example, in some embodiments, the counterparties can reach an agreement by voice (e.g., in person, via telephone, etc.) or electronically (e.g., via a trading platform). Once an agreement is reached, an affirmation platform (e.g., such as affirmation platform 106 of FIG. 1), a swap execution facility (e.g., such as swap execution facility 108 of FIG. 1), an exchange (e.g., such as exchange 110 of FIG. 1), or any other suitable mechanism can be used to provide information on the trade to process 200 via any suitable communication path using any suitable protocol. For example, in some embodiments, this information may be provided to process 200 via the Internet using messages in the FIX protocol.

As illustrated in FIG. 2, at 202, process 200 can receive information for the trade.

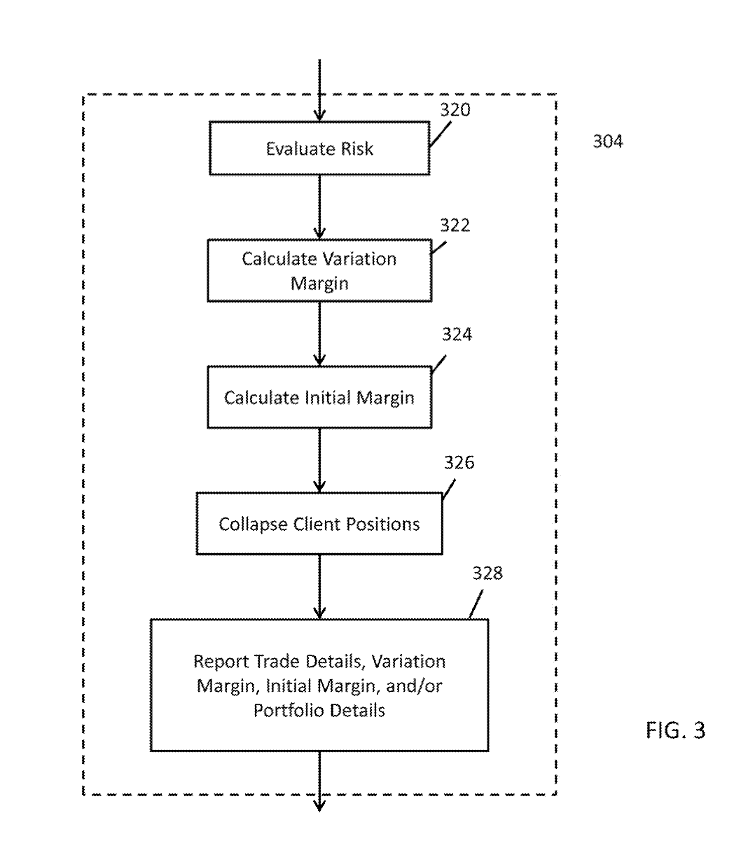

Next, at 204, process 200 can clear the trade for execution. Any suitable mechanism for clearing the trade can be used in some embodiments. For example, a process 304, as illustrated in FIG. 3 and described below, can be used to clear a trade in some embodiments.

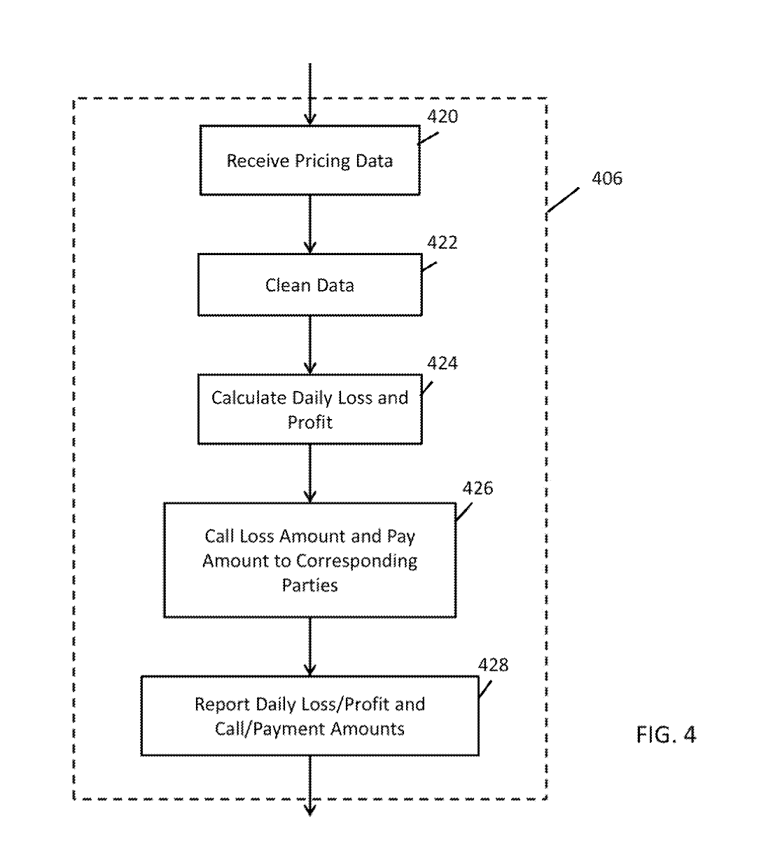

At 206, process 200 can mark the trade to market. Any suitable mechanism for marking the trade to market can be used in some embodiments. For example, a process 406, as illustrated in FIG. 4 and described below, can be used to mark a trade to market in some embodiments.

Then, at 208, process 200 can determine if a trade is going to expire. Any suitable mechanism for determining that the trade has expired can be used in some embodiments. For example, in some embodiments, a trade in a forward swap spread can be determined to have expired on its expiration date. If it is determined that the trade has not yet expired, process 200 can loop back to 206.

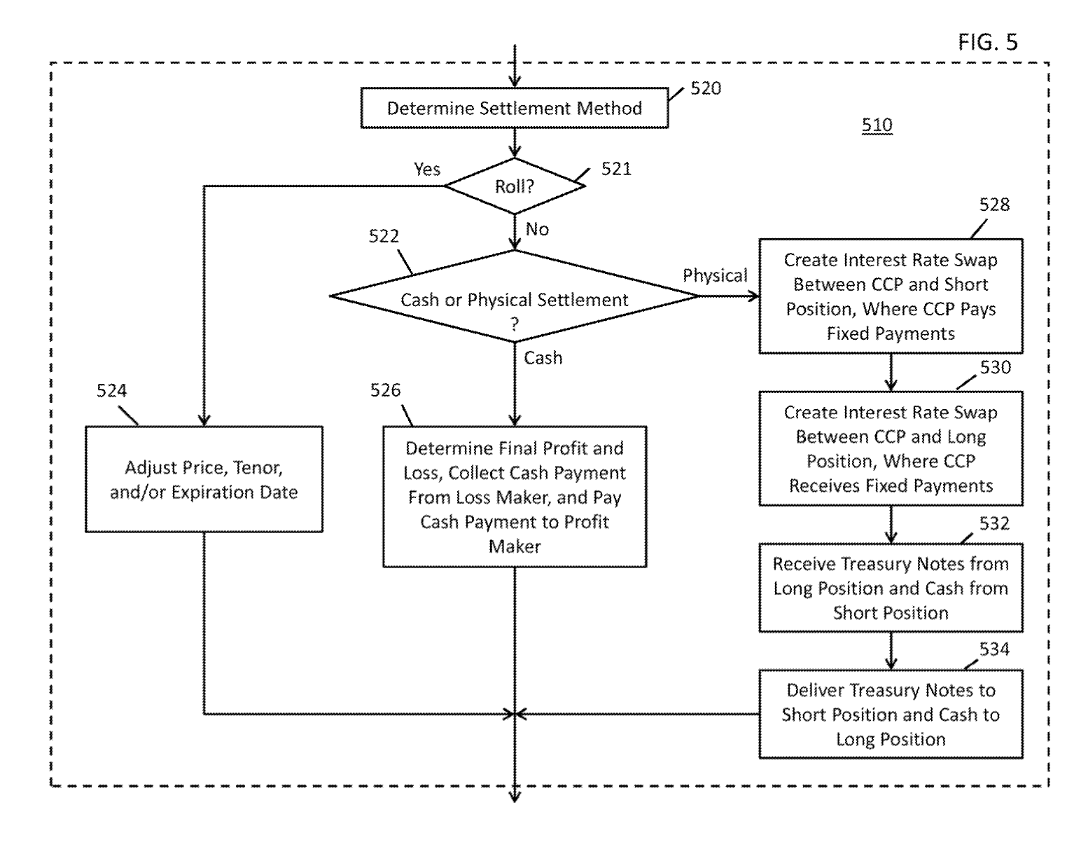

Otherwise, if process 200 determines at 208 that the trade has expired, the process can settle the trade at 210. Any suitable mechanism for settling trade can be used in some embodiments. For example, a process 510, as illustrated in FIG. 5 and described below, can be used to settle a trade in some embodiments.

After settling a trade at 210, process 200 can end.

Turning to FIG. 3, a flow chart of an example 304 of a process for clearing a trade in accordance with some embodiments is shown. As illustrated, at 320, process 304 can evaluate the risk associated with clearing a trade. Any suitable mechanism for evaluating the risk associated with clearing a trade can be used in some embodiments. For example, in some embodiments, process 304 can check the trade for validity based on the details and the economic attributes of the trade. As another example, in some embodiments, both counterparties of the trade can be checked for credit, eligibility, and/or any other suitable characteristics.

At 322, the variation margin for the trade can be calculated. The variation margin can be calculated in any suitable manner in some embodiments. For example, in some embodiments, that variation margin can be calculated as described below in connection with steps 422, 424, and 426 of FIG. 4.

At 324, the initial margin for the trade can be calculated. Initial margin can be amount of collateral to be collected and utilized by a central counterparty in the event that a member defaults on a trade.

The initial margin can be calculated in any suitable manner in some embodiments.

For example, in some embodiments, the initial margin of the trade can be calculated based on historical value at risk and the risk of the trade. More particularly, for example, historical swap spread positions plus any additional “add on” to account for the additional risk of the “forwardness” can be used to calculate risk associated with a trade. Historical swap spread positions can be obtained from any suitable source, such as date on spot swap spreads. The risk of the forwardness can be based on how much it is anticipated that the forwardness of the spread can potentially move based on the time to expiry.

As another example, in some embodiments, initial margin can be calculated for each trade in portfolio (a portfolio is a collection of trades associated with a specific counterparty). To calculate initial margin for each trade in a portfolio, a DV01 ladder can be created for each product (a product may be, for example, a USD fixed-float IRS with a maturity of as little as 3 days or as long as 50 years (plus 2 days), another product may be a EUR fixed-float IRS, another product may be a USD overnight index swap). A DV01 ladder for a given product identifies DV01 exposure for each of a one or more maturity date ranges associated with a counterparty's position(s) in that product. Any maturity date range(s) can be used in some embodiments. For example, in some embodiments, one maturity date range can be for all positions in a product that mature within 1.5-2 years from today, and another bucket can be for all positions in the product that mature 2-3 years from today.

To calculate the initial margin of the portfolio, the gain or loss of the portfolio at every maturity range for every product over a trailing period (i.e., over the last 5 years or more) can be calculated. One or more worst case losses of the portfolio over the trailing period can then be determined, a single loss figure can be calculated, and the customer can be required to post initial margin matching the single loss figure. Any suitable one or more worst case losses can be used in some embodiments. For example, the worst loss, the third worst loss, an average of the four worst losses, etc. can be used depending upon current industry best practice and other considerations in some embodiments.

In some embodiments, the IM calculation can be based on the time series of the swap spread history (which is readily available).

The DV01 of the swap side of the contract can be calculated, the whole contract can be assumed to be delta neutral (i.e., rate hedged) with treasuries offsetting the risk of the swap side.

Next, at 326, each counterparty's positions can be collapsed. These positions can be collapsed in any suitable manner. For example, in some embodiments, trades with the same economic process are compressed to one line item. For example, a buy of $100M of a ten year maturity, forward swap spread, at 55 basis points and a sell of $25M of a ten year maturity, forward swap spread, at 55 basis points can be net down to one buy of $75M of a ten year maturity, forward swap spread at 55 basis points.

At 328, data can be provided regarding trade details, variation margin, initial margin, product details, and/or any other suitable data. For example, this data can include trade details (e.g., the start date of the swap, payment dates, etc.), the position details of a customer (e.g., Client X has three trades on at Y price), the valuation of each trade, the initial margin requirement of each portfolio, the timing at which each trade is clearing, etc.

This data can be provided in any suitable manner. For example, in some embodiments, this data can be provided via flat files (i.e. CSV files, tab-delimited files, etc.) and any suitable application programming interface.

Turning to FIG. 4, a flow chart of an example 406 of a process for marking a trade to market in accordance with some embodiments is shown. Marking a trade to market is determining the change in value of the trade for each party to the trade.

In some embodiments, a trade can be valued or marked to market in any suitable manner. For example, in some embodiments, a mark-to-market can be based upon dealer-contributed data and/or based upon an algorithm for calculating variation margin. Continuing with FIG. 4, marking a trade to market based on dealer-contributed data is described.

As shown, at 420, a series of market data points can be received. These data points can be received in any suitable format. For example, these data points can be represented as a spread or as a price. These data points can account for different swap spread levels for different maturity and for the forwardness. The forward spread can be calculated for all expiries and maturities (e.g., two to three contracts/expiries for each maturity, such maturities as two year, five year, ten year, and thirty year).

Next, as 422, the data points can be cleaned using any suitable process. For example, in some embodiments, the data points can be cleaned using a market standard data cleaning process to calculate a consensus bid, ask, and/or mid spread level or closing spread level and the change from the last mark-to-market process used to value the positions of all customers. In some embodiments, the spread can then be converted to a U.S. dollar based price in order for the central counterparty to collect mark-to-market losses from loss making clients to pay mark-to-market gains to profit making clients.

Once the data is cleaned, it can be used at 424 to calculate the daily loss or profit.

Any suitable mechanism can be used to calculate the daily loss or profit in some embodiments. For example, in some embodiments, the closing spread change can be multiplied by the DV01 of the underlying forward interest rate swap to calculate the daily loss or profit (i.e., the variation margin).

DV01 is short hand for the “dollar value of a basis point” and represents the dollar value impact of a one basis point change in an instrument's yield or equivalent currency based on an underlying and as is also sometimes referred to as PV01 or “delta” (a basis point represents a 0.01% yield). Yield and yield-to-maturity are terms commonly used in financial markets to represent annualized return of an instrument that makes periodic interest rate payments. DV01 is a measure commonly used to convert the yield measure into a price or quantify exposure. Market participants use DV01 so that they can understand the price impact of a one basis point (or more) shift in yields.

In some embodiments, DV01 can be calculated either analytically or empirically. For example, to calculate DV01 empirically, the inputs to the valuation curve can be perturbed and the resulting change in net present value (NPV) of the trade can be determined.

For the forward swap spread, the DV01 of the forward swap can be used to give the DV01 of the forward swap spread position when it is assumed that the spread product represents a DV01 neutral position (i.e., the DV01 of the swap position is offset by an opposite DV01 on the treasury position). The size of the offsetting treasury position upon expiration equals the DV01 of the swap position (based on the notional size) divided by the DV01 of the underlying treasury security.

For example, assume that a counterparty buys $100M, ten year forward swap spread contract with an expiry of Mar. 17, 2013 at a spread of 50.00 basis points. Also assume for purposes of the example that the ten year U.S. Treasury is yielding 2.00% and the market swap rate is 2.50%.

In such a case, the DV01 of a reference forward ten year swap that begins on Mar. 17, 2013 and ends on Mar. 17, 2023 is $88,200.00 calculated using a market standard DV01 calculation. Thus, the spread position would have the following DV01s:

| Swap | Treasury |
|---|---|
| $88,200.00 | $−88,200.00 |

This means that the buyer of the contract gains (or loses) $88,200.00 if the yield of the swap increases (or decreases) by one basis point and loses (or gains) $88,200.00 if the yield of the treasury increases (or decreases) by one basis point.

In this example, the buyer of the spread gains if the spread widens, but does not have risk to outright rate moves that affect both underlying instruments equally.

For example, if the yield of the swap were to move to 2.51% and the yield of the treasury were to move to 2.01% the holder would have a gain of $88,200.00 in the swap offset by a loss of $88,200 in the treasury (as the spread between the two instruments remained constant at 50.00 bps). In this simplified example, the variation margin of the buyer and seller would be approximately $0.00.

However, if instead the swap yield were to increase to 2.52% while the yield of the treasury were to decrease to 1.99%, the holder would have a gain of $264,600.00. This would reflect the two basis point multiplied by $88,200.00 of the swap plus the minus one basis point multiplied by the $−88,200.00 of the treasury. This is consistent with the three basis point increase in the spread. In this case, the seller would pay the central counterparty $264,600.00 that the central counterparty will pay to the buyer.

In some embodiments, the payment owed to a profit maker can be reduced by an amount based on an overnight interest rate and this amount can then be paid to the loss maker (or credited against the payment owed by the loss maker), an example of this is commonly known as Price Alignment Interest (PAI).

In some embodiments, at expiry, the DV01 of the official spot starting swap can be calculated based on the final closing swap, treasury, and spread levels. The precise hedge ratio in millions can then be determined as (total DV01 of the swap)/(treasury DV01 per million of notional). This calculation provides the notional amount of the treasury position. If the contract is physically settled, then this calculation determines the size of the treasury position that the counterparty must deliver (or purchase).

At 426, a call for the daily loss (or variation margin) can be made to the loss maker, and once that payment is received, a payment of the daily profit (or variation margin) can then be made to the profit maker. In some embodiments, the call can be implemented as an automatic deduction by a central counterparty of an account of the loss maker and as an automatic payment by a central counterparty to an account of the profit maker. For example, the automatic deduction and the automatic payment can be implemented by a computer executing process 406.

At 428, process 406 can report daily loss/profit and call/payment amounts to each counterparty. This reporting can be performed in any suitable manner.

Turning to FIG. 5, a flow chart of an example 510 of a process for settling a trade in accordance with some embodiments is shown.

In some embodiments, holders of a financial instrument, such as a forward swap spread, can choose a settlement method at the time of submitting the instrument for clearing, the day prior to expiry of the financial instrument, or at any other suitable time.

Any suitable method for settling a trade, such as a forward swap spread, can be used in some embodiments. In addition, as described above, in some embodiments, a forward swap spread can be rolled forward to an expiry further in the future or can be settled by cash settling the forward swap spread, or by physically settling the forward swap spread.

As illustrated in FIG. 5, the process can begin at 520 by determining the settlement method. This settlement method can be determined in any suitable manner. For example, this settlement method can be determined by evaluating trade information, such as trade information received at 202 of FIG. 2, by prompting the counterparties to the trade to make a decision at a given point in time, or by any other suitable mechanism, in some embodiments.

Next, at 522, process 510 can determine whether the settlement method is to roll the trade, cash settle the trade, or physically settle the trade. If it is determined at 522 that the settlement method is to roll the trade, then process 510 can roll the contract forward at the mid (or other appropriate) level between the forward swap spread and spot swap spread (i.e., mid means at mid-market level).

In some embodiments, rolling a trade forward may only be available when both counterparties to the trade have requested to roll. Otherwise, contracts may be required to be cash or physically settled.

In rolling the contract forward, process 510 can adjust the maturity (or sometimes referred to as the ‘tenor’) and/or expiration date of the contract and designate the contract as unexpired. Adjusting the tenor and expiration date, can be performed in any suitable manner.

If it is determined at 522 that the trade is to be cash settled, process 510 can determine the final profit and loss on the trade, collect cash payment from the loss maker, and pay cash payment to the profit maker at 526.

In determining the final profit and loss, variation margin can be calculated on the trade for the last time and the contract expired. The variation margin can be calculated as the difference between NPV (net present value) of the on-market (the current market rate) swap spread versus the agreed upon spread forward ((Spread 1−Spread 2)*DV01) in some embodiments. In some embodiments, overnight interest may also be paid to the payer of the variation margin by the receiver of the variation margin.

If it is determined at 522 that the trade is to be physically settled, process 510 performs steps 528, 530, 532, and 534.

At 528, process 510 can create an interest rate swap between the central counterparty and the short position counterparty, where the central counterparty pays fixed payments. The terms of the interest rate swap can be governed by the current spot spread market.

At 530, process 510 can create an interest rate swap between the central counterparty and the long position counterparty, where the central counterparty receives fixed payments. The terms of the interest rate swap can be governed by the current spot spread market.

At 532, process 510 can receive treasury notes from one counterparty and can receive cash from the other counterparty. The weighted government bonds can be locked (i.e., a price can be set) at that time in some embodiments.

Finally, at 534, the received treasury notes can be delivered by the central counterparty to one counterparty (likely the fixed rate payer) and the received cash can be delivered by the central counterparty to the other counterparty (likely the floating rate payer).

In some embodiments, the interest rate swaps created at 528 and 530 are not executed until the treasuries are delivered to the central counterparty at 532.

In some embodiments, the delivery of treasuries and cash at 532 and 534 can be controlled in an automated manner by process 510. For example, at 532, the process can issue an electronic request (or “a call”) message to the counterparty to deliver the treasuries, in response to which the counterparty will deliver the treasuries in a certain period of time. The process can also automatically deduct cash from an account of the short position counterparty at 532. At 534, process 510 can automatically deliver the received treasuries into an account of the short position holder, and can automatically deliver the received cash into an account of the long position holder.

It should be understood that some or all of the above steps of the flow diagrams of FIGS. 2-5 can be executed or performed in an order or sequence other than the order and sequence shown and described in the figures. Also some of the above steps of the flow diagrams of FIGS. 2-5 may be executed or performed well in advance of other steps, or may be executed or performed substantially simultaneously or in parallel to reduce latency and processing times.

In some embodiments, any suitable computer readable media can be used for storing instructions for performing the processes described herein. For example, in some embodiments, computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

Although the invention has been described and illustrated in the foregoing illustrative embodiments, it is understood that the present disclosure has been made only by way of example, and that numerous changes in the details of embodiment of the invention can be made without departing from the spirit and scope of the invention, which is only limited by the claims which follow. Features of the disclosed embodiments can be combined and rearranged in various ways.

What is claimed is:

1. A method for executing a trade, comprising the steps of:
receiving, by a central counterparty, a contract having transaction terms associated with an interest rate swap and a position of a security, the transaction terms including an expiration date;
upon the expiration date:
generating the interest rate swap based on the transaction terms,
facilitating, by the central counterparty, delivery of the security from a second counterparty to a first counterparty; and
starting on a specified date after the expiration date:
receiving, by the central counterparty, payment of a fixed side of the interest rate swap from the first counterparty,
paying, by the central counterparty, the fixed side of the interest rate swap to the second counterparty,
receiving, by the central counterparty, a floating side of the interest rate swap from the second counterparty, and
paying, by the central counterparty, the floating side of the interest rate swap to the first counterparty.

2. The method of claim 1, wherein in a case of a cash settlement of the contract:
upon a specified date after the expiration date:
cash settling the contract based on a market value of the contract.

3. The method of claim 1, wherein the transaction terms require the first counterparty and second counterparty to enter into the interest rate swap and the position of the security on the specified date.

4. The method according to claim 1, further comprising the steps of:
calculating a settlement value based on a basis point change in a rate of the contract.

5. The method according to claim 1, wherein a basis point change in the contract corresponds to a change of a spread between the interest rate swap and the security.

6. The method according to claim 1, wherein a basis point change of a market spread associated with the contract results in a net present value (NPV) change of the contract.

7. The method according to claim 1, wherein a final notional amount of the security is determined by a final DV01 of the interest rate swap upon the expiration date such that the DV01 of the interest rate swap and the security are equal and offsetting.

8. The method according to claim 1, wherein a final yield of the security for final settlement is based upon a difference between the interest rate swap and a transacted spread of the contract.

9. The method according to claim 1, wherein a DV01 of the contract is determined by a DV01 of the interest rate swap, such that a DV01 of the security and the DV01 interest rate swap are equal and offsetting at final settlement and throughout the life of the contract.

10. The method according to claim 1, further comprising the step of:
generating, prior to the expiration date, a value of a spread corresponding to a current market rate of the interest rate swap and a yield of the security.

11. The method according to claim 1, further comprising the steps of:
calculating a difference between a change in net present value (NPV) of the contract, wherein the change in NPV is a difference between a first spread (Spread 1) of the contract and a second spread (Spread 2) of the contract multiplied by a value of a basis point change in a value of the interest rate swap (DV01) prior to and on the expiration date ((Spread1−Spread2)*DV01), wherein the first spread is a pre-stored mark of a market spread and the second spread is a mark of a current market spread.

12. The method according to claim 1, wherein a first spread of the contract and a second spread of the contract are based on a spread between a government bond and an associated interest rate swap associated with anyone one of a German debt, United Kingdom debt, Italian debt, Australian debt, United States debt, or Canadian debt.

13. The method according to claim 1, wherein the security is a government bond, a corporate bond, or an agency security.

14. The method according to claim 1, further comprising the step of:
converting a spread position to a settlement price.

15. The method according to claim 1, further comprising the step of:
establishing a hedge ratio to calculate a position of the security.

16. The method according to claim 1, further comprising the step of:
modifying a settlement post-trade execution from a physical form to cash or from cash to the physical form.

17. The method according to claim 1, further comprising the step of:
determining a settlement post-trade execution from a physical form to cash or from cash to the physical form.

18. A system for executing a trade, comprising:
a processor in communication with a memory, the memory storing instructions that, when executed by the processor, cause the processor to be operate to control:
reception, by a central counterparty, of a contract having transaction terms associated with an interest rate swap and a position of a security, the transaction terms including an expiration date;
upon the expiration date:
generation of the interest rate swap based on the transaction terms,
facilitating, by the central counterparty, delivery of the security from a second counterparty to a first counterparty; and
starting on a specified date after the expiration date:
reception, by the central counterparty, of a payment of a fixed side of the interest rate swap from the first counterparty,
payment, by the central counterparty, of the fixed side of the interest rate swap to the second counterparty,
reception, by the central counterparty, of a floating side of the interest rate swap from the second counterparty, and
payment, by the central counterparty, of the floating side of the interest rate swap to the first counterparty.

19. A non-transitory computer-readable medium having stored thereon one or more sequences of instructions for causing one or more processors to perform:
receiving, by a central counterparty, a contract having transaction terms associated with an interest rate swap and a position of a security, the transaction terms including an expiration date;
upon the expiration date:
generating the interest rate swap based on the transaction terms,
facilitating, by the central counterparty, delivery of the security from a second counterparty to a first counterparty; and
starting on a specified date after the expiration date:
receiving, by the central counterparty, payment of a fixed side of the interest rate swap from the first counterparty,
paying, by the central counterparty, the fixed side of the interest rate swap to the second counterparty,
receiving, by the central counterparty, a floating side of the interest rate swap from the second counterparty, and
paying, by the central counterparty, the floating side of the interest rate swap to the first counterparty.
